(19) United States
(12) Patent Application Publication
(10) Pub. No.: US 2012/0137237 A1
(43) Pub. Date: May 31, 2012

(54) SYSTEM AND METHOD FOR DIGITAL IMAGE AND VIDEO MANIPULATION AND TRANSFER

(75) Inventors: Andrew Brenner, Sunnyvale, CA (US); Vince Nakayama, Los Altos, CA (US); Cole Poelker, San Francisco, CA (US); Aubrey Anderson, San Francisco, CA (US)

(73) Assignee: Sony Corporation, Tokyo (JP)

(21) Appl. No.: 13/115,826

(22) Filed: May 25, 2011

Related U.S. Application Data
(60) Provisional application No. 61/373,566, filed on Aug. 13, 2010.

(51) Int. Cl. G06F 3/048

(52) U.S. Cl. 715/763

(57) ABSTRACT

A system, method, and computer program product for automatically manipulating and sharing multimedia content items by acquiring them, defining related item information via graphical user interface, and transferring the items and the related item information to selected destinations whereby the related item information is retained. The related item information includes metadata and collection definition, including transfer constraints and destination requirements. Embodiments may be implemented on potentially network-attached computers and cameras, and transfer content to email accounts, archives, social networks and content publication sites. The graphical user interface includes function-specific areas for easy, fast use. Destinations are identified by name and logo, and may include an interchange server that dynamically updates end destination requirements and responsively adapts further transfers. Transfers may be immediate or occur on demand or at the time of device-network connection, and may include computer-executable program instructions for implementing the graphical user interface.

### CROSS-REFERENCE TO RELATED APPLICATIONS

This utility patent application claims priority to U.S. Provisional Patent Application No. 61/373,566, filed on Aug. 13, 2010, entitled “Digital Image and Video Manipulation and Transfer,” the benefit of which is claimed under 35 U.S.C. 119, and is further incorporated herein by reference.

### FIELD OF THE INVENTION

The present patent document relates in general to managing multimedia content, more specifically to manipulating and sharing photos, videos, and other multimedia content via various computer sites and social networks.

### BACKGROUND OF THE INVENTION

Digital cameras are becoming cheaper, more powerful, and more widely used. High resolution images and high definition videos can be immediately captured and stored on high capacity memory devices for less than what a good SLR film camera once cost. Currently available digital cameras also typically have color displays to show captured images and videos on the spot.

Social networks are becoming increasingly popular. Sites and/or services like YouTube™, Facebook™, Picasa™, and others enable users to distribute text, images, and videos via the internet. Unfortunately, managing images, videos, and other multimedia content items can be complicated. Subsequently transferring these items to online sites can involve additional user aggravation and drudgery, as each site may have its own application program interface (API) and constraints on uploads, and these may change over time.

People who want to manage and share content can be divided into different possible market segments. The “habitual sharers” for example want simplicity and speed to “share the moment” with friends or to show off something they did. Their photos are ephemeral and are intended for rapid effortless sharing via a social network using software that does not “get in the way”. The “family historians” in contrast want sufficient content management tool sophistication for serious projects. This group is generally interested in capturing treasured memories of important events, then organizing, preserving them essentially forever, and reliving them or sending them privately.

Both of these user groups want to annotate content items and assemble them into presentations or collections, but may prefer not to modify original multimedia content items. Instead, they would provide additional material that is linked to the original items and transferred along with items for correlated presentations. Both user groups may also prefer to do these tasks directly with a digital camera, if that option were available, versus requiring subsequent computer interaction. As a result, there is a need for an in-camera tool to easily automatically manipulate and share photos, videos, and other content via various computer sites and social networks.

### SUMMARY OF THE EMBODIMENTS

A system, method, and computer program product for automatically manipulating and sharing multimedia content items are disclosed and claimed herein. Exemplary embodiments acquire multimedia content items, then present a graphical user interface by which a user may define information related to the items. The multimedia content items and the related item information are then transferred to selected destinations, whereby the related item information is retained. Multimedia content items may include a text file, a photograph, a video, an audio file, an HTML file, a mixed media presentation, a PDF document, an executable program file, a database file, or other content items and combinations thereof as may be known in the art. The multimedia content items may be input from or acquired from a camera, a phone, a scanner, a memory device, an email, a network, a computer, or other content sources as may be known in the art.

Embodiments, or a human user, may edit the original multimedia content items by adding captions, dates, and notes, or by cropping the items, reducing the items' file size, reducing the duration of video or presentation type items. Embodiments, or a human user, may also add metadata or specify the formation of a multimedia content item collection. Adding metadata includes preserving the original multimedia content items but providing additional information that governs its modification during presentation; as previously noted such modifications may include adding captions, dates, and notes, as well as adding names to images having automatically recognized faces. The formation of a collection may include selecting particular multimedia content items, determining an attachment sequence, setting transfer constraints, and defining destination constraints.

Embodiments may represent the multimedia content items and the related item information in a graphical user interface by icons, thumbnails, or collection tokens. The graphical user interface may be implemented on a touchscreen device, a camera, or a computer, each of which may be attachable to a network. The graphical user interface may include function-specific areas such as a main stage, a filter area, a collection assembly area, a user guidance area, persistent context-sensitive action buttons, and a sharing dock with destination containers.

The transferring of multimedia content items or collections and the related item information includes moving a multimedia content item or a collection token into a destination container on the graphical user interface. The destination container may be easily identified by the user by incorporating a label with a name or logo. The transfer may be immediate or delayed for a predetermined time or until a connection is made, according to a user-defined transfer constraint. The designated destinations may include public or private sites, email accounts, social networking sites, content publishing sites, interchange servers, and archives.

In one embodiment, the destination is an interchange server that automatically manages an additional transfer to an additional destination that has its own destination constraints. In this manner, a given multimedia content management tool can leave the management of the transfer details to the interchange server, which may dynamically update its operations in accordance with changing destination constraints. In another embodiment, computer-executable program instructions for implementing the graphical user interface may be transferred from a first computing device to a second computing device. In this manner, the multimedia content and the multimedia content management tool may both be portable together.

As described more fully below, the apparatus and processes of the embodiments disclosed permit automatic management and sharing of multimedia content items. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIGS. 1A and 1B depict a digital camera based implementation of an embodiment;

FIG. 2 depicts a graphical user interface according to an embodiment;

FIG. 3 depicts the assembly of several multimedia content items into a collection according to an embodiment;

FIG. 4 depicts a graphical user interface including facial recognition according to an embodiment;

FIG. 5 depicts a graphical user interface including video management according to an embodiment;

FIG. 6 depicts a flowchart of an embodiment.

### DETAILED DESCRIPTION OF EXEMPLARY EMBODIMENTS

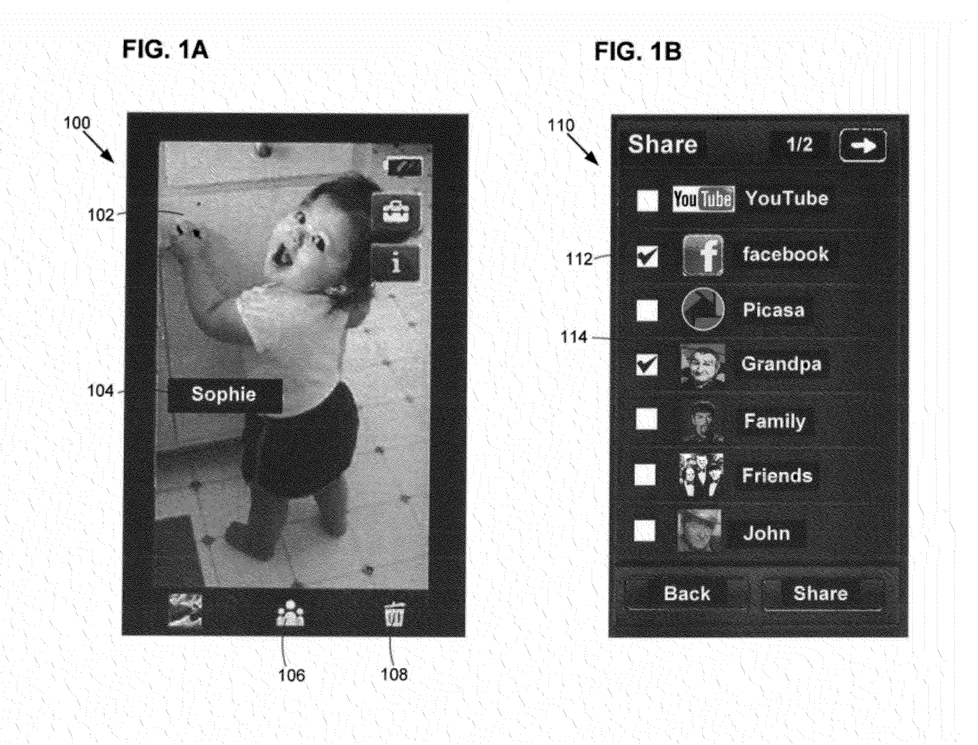

Referring now to FIGS. 1A and 1B, a digital camera based implementation of an embodiment of the invention is shown. Implementations may also be on another touchscreen device such as a smartphone, or may be on a computer (not shown). The hardware portions of the embodiment may also be networked.

As shown in FIG. 1A, digital camera 100 includes display 102 that shows a captured image as well as superimposed icons and user-provided label 104. The label is a software tag that is integrated with the image during display, though the captured image file may or may not be edited itself to include the label. The software tag is thus an example of information related to the content item that may be linked with the item and carried along as metadata. The camera also has icons for sharing 106 and discarding 108 images or videos.

As shown in FIG. 1B, upon selection of the sharing icon, graphical user interface 110 for sharing is presented. Checkboxes 112 may be individually selected to enable content sharing to particular destinations 114, including social networking sites/services (e.g. YouTube™, Facebook™, Picasa™) or email accounts (e.g. grandpa, family, friends, John) that have been previously defined. The destinations may be identified by labels with names, thumbnails, and logos as shown.

Further, an explanatory movie (not shown) can be played on power-up of the camera to help users understand the camera's features. Power-up should preferably occur in less than a second for fast image acquisition. Use of a common look and feel between different products made by the camera's manufacturer will also help reduce user confusion. The camera may be the Sony® Bloggie Touch™ product for example.

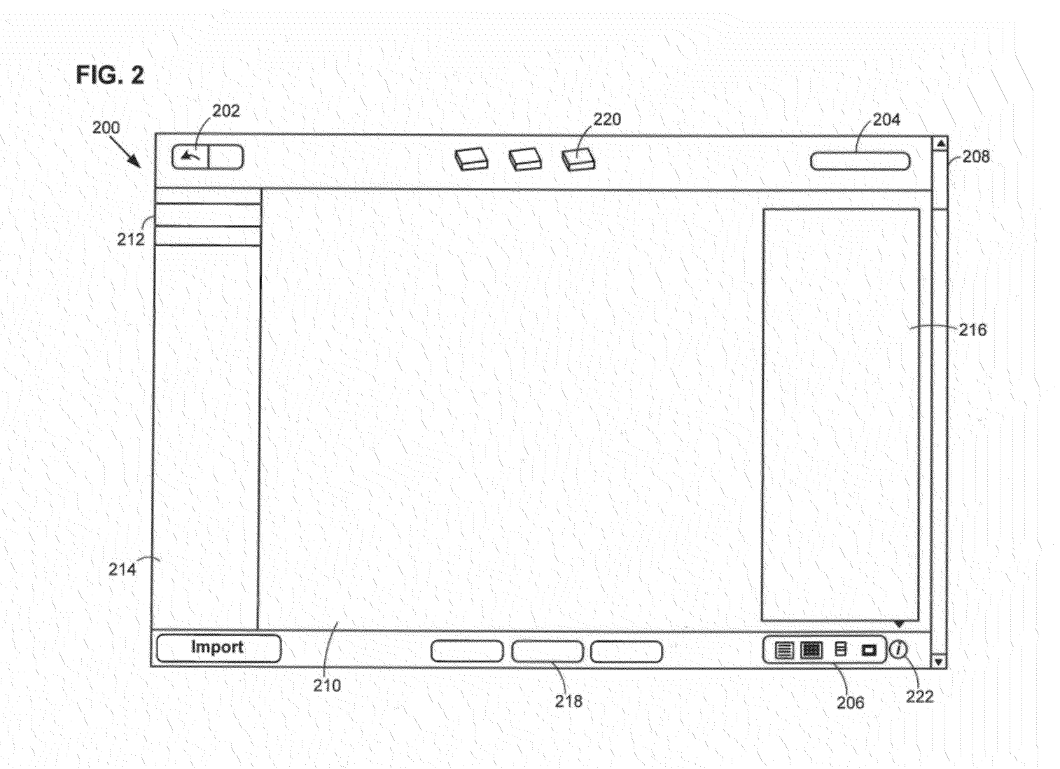

Referring now to FIG. 2, graphical user interface 200 according to an embodiment on a computer is shown. This embodiment is more sophisticated than that shown in FIGS. 1A and 1B, and it is capable of handling multiple multimedia content items simultaneously. These content items may include for example text files, photographs, videos, audio files, HTML files, mixed media presentations, PDF documents, executable program files, or database files. The content items may be input or acquired from a camera, a phone, a scanner, a memory device, an email, a network, or a computer for example.

The graphical user interface has several features that will be discussed in turn. Unlike conventional graphical user interfaces, there is no traditional menu bar nor file folders as used with conventional pointing devices, because this interface may be used with touchscreen devices. Undo button 202 allows actions to be undone, as is familiar to users of web browsers. A redo button (not shown) may also be implemented. Search bar 204 accepts search terms from a user to help identify relevant multimedia content items, for example by searching metadata. View selection buttons in views bar 206 enable a user to view multimedia content items one at a time, two at a time, as a list, or as a grid of thumbnails. Slider bar 208 lets a user navigate through presented items.

The graphical user interface further comprises function-specific areas including main stage 210, filter area 212, collection assembly area 214, user guidance area 216, persistent context-sensitive action buttons 218, and a sharing dock with destination containers 220. The main stage is the primary central display area where icons or thumbnails representing multimedia content items are shown and arranged for viewing and manipulation. The items are brought into the main stage by direct acquisition, or importation from a memory or attached or networked devices for example.

Help icon 222 is provided to trigger presentation of user instructions in the user guidance area, also referred to as the “voice” area. The voice area provides important information and helpful tips on how to do things, what options are currently available (e.g. display or edit metadata), and provides a modal dialog or wizard to guide the user. The main stage can be resized depending on “voice” area actions, i.e. the voice area can temporarily take more display space as needed. The filter area comprises several filter tabs that can be applied to content items in the main stage so a user can identify those items meeting desired filter criteria, such as ‘last viewed’ or ‘last imported’ or ‘view trash can’ for example. Items may also be selected based on their metadata content.

Persistent context-sensitive action buttons are provided to indicate to the user what primary actions are available. These actions are available at the bottom of the interface for example and are context-sensitive, i.e. they change based on user actions to denote currently operable commands. The sharing dock with destination containers is shown at the top of the interface in this exemplary embodiment. Destination containers are easily accessible icons representing folders in which multimedia content items may be stored. The containers may have labels including names or logos on them for easy user recognition of corresponding destinations.

Items or collections of items placed in containers, e.g. by dragging and dropping, are queued for sharing to selected destinations, so the user can see past or pending transfers. The destinations may include public or private sites, email accounts, social networking sites, content publishing sites, interchange servers, and archives, for example. Transfers to destinations may occur immediately, upon docking with a computer or other device, after a user-specified delay, in response to a user command, or in response to other predetermined transfer conditions being met. The user can simply store items to be transferred in an output buffer by selecting a “share later” button (not shown).

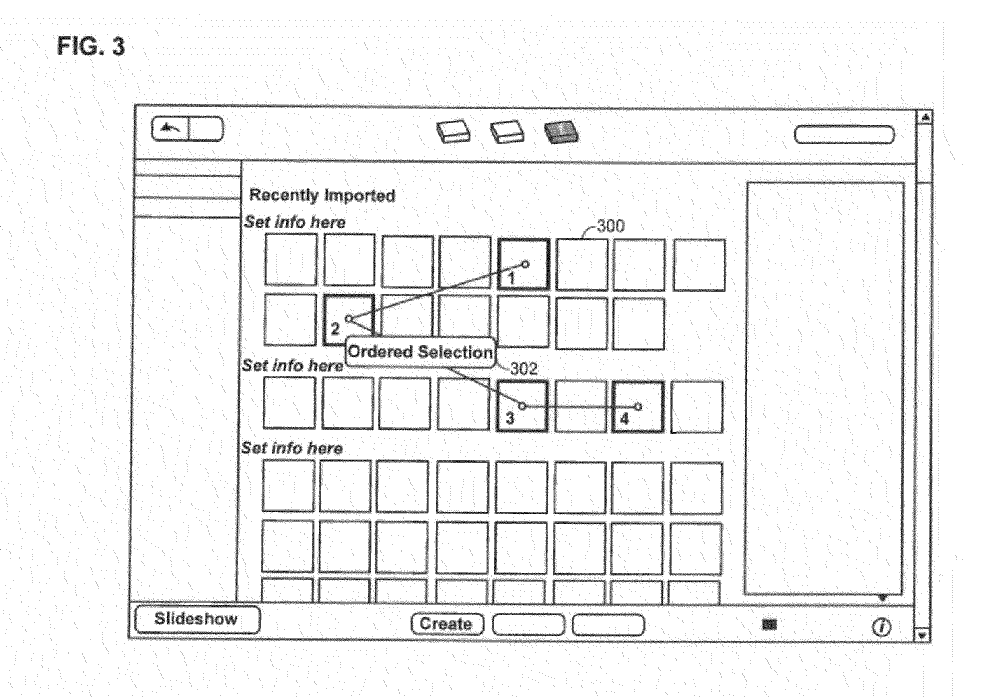

Referring now to FIG. 3, the assembly of several multimedia content items 300 into a collection (or “set” 302) according to an embodiment is shown. A user can select one or more items depicted in the main stage and move it or them to the collection assembly (or “sticky”) area for assembly with other items into a collection (also referred to as an album or volume). Multiple items may be selected by holding down a control button during selection in a conventional interface, or an equivalent functional command in a touchscreen interface. The items can then be dragged and dropped into position as additions to the collection. Once the collection is finished, it can be dragged and dropped into a destination container to be queued for transfer.

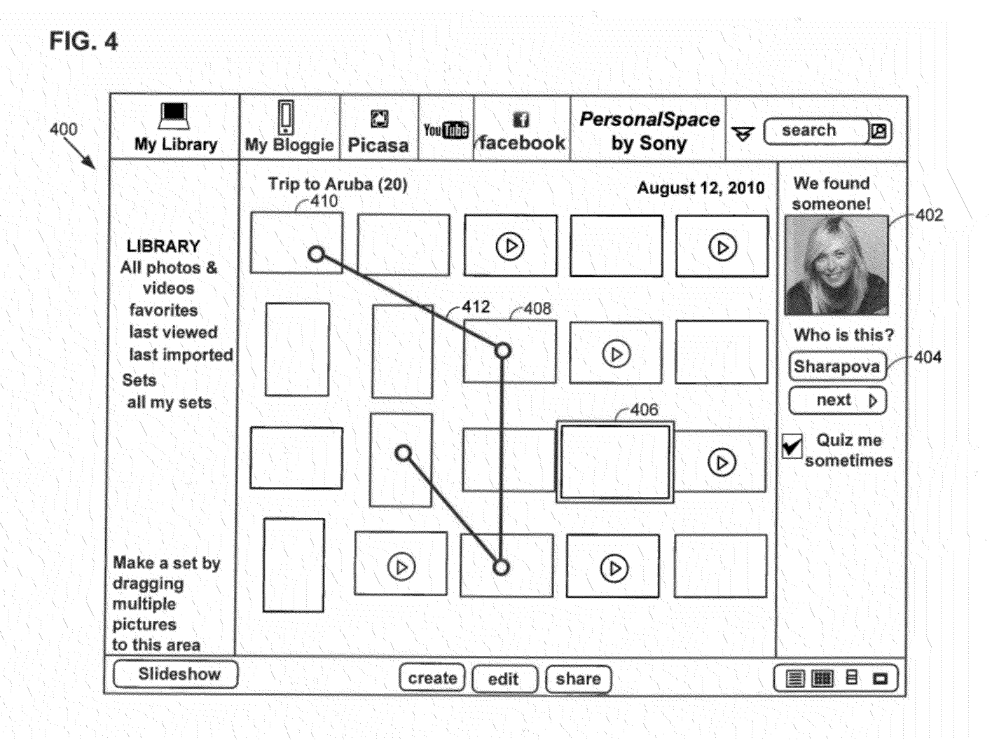

Referring now to FIG. 4, graphical user interface 400 including facial recognition according to an embodiment is shown. Multimedia content items may be subjected to a facial recognition process, so that persons detected in images or videos can be automatically noted in metadata associated with the item. Embodiments may determine that some items feature previously unrecognized person 402, and may selectively prompt the user for the name 404 of that person. The item 406 containing the unrecognized person may be highlighted in the interface.

Also shown in this embodiment, the graphical user interface also provides a feature by which relationships among multimedia content items can be more clearly defined. If a user selects one item 408 after another 410 in the main stage, the interface can highlight each selected item and connect them by lines, forming a persistent wireframe or constellation that serves as a collection token 412. The token is a visual depiction of relationships between items, i.e. that they are grouped and are in a presentation sequence corresponding to the order of their assignment to the collection. The concept is similar to threading beads on a string. Tokens can then be manipulated as single items are manipulated, i.e. annotated and dragged to a destination container when ready for transfer. The user can thus share the collection the same way to any group at the same time. This greatly simplifies the process of manipulating and sharing collections to various destinations.

Each destination may have its own sharing schemes that are potentially confusing and require significant user involvement. To address this problem, embodiments may include an interchange server that automatically manages an additional transfer to an additional destination that has its own destination constraints. In this manner, a given multimedia content management tool can leave the management of the transfer details to the interchange server, which may dynamically update its operations in accordance with changing destination constraints. The interchange server may comprise the Sony® Personal Space™ product.

By communicating with the interchange server using a common interface, an embodiment can offload the constraint management and publication process from there. Social networking sites and web publishing services routinely change their constraints, but it is desirable to avoid manual updates to one's digital camera featuring a particular interface so the camera doesn't become outdated. The interchange server can also alter or turn on/off services by country or by popularity of services.

In another embodiment, computer-executable program instructions for implementing the graphical user interface may be transferred from a first computing device to a second computing device. The multimedia content and the multimedia content management tool may thus both be transferred together.

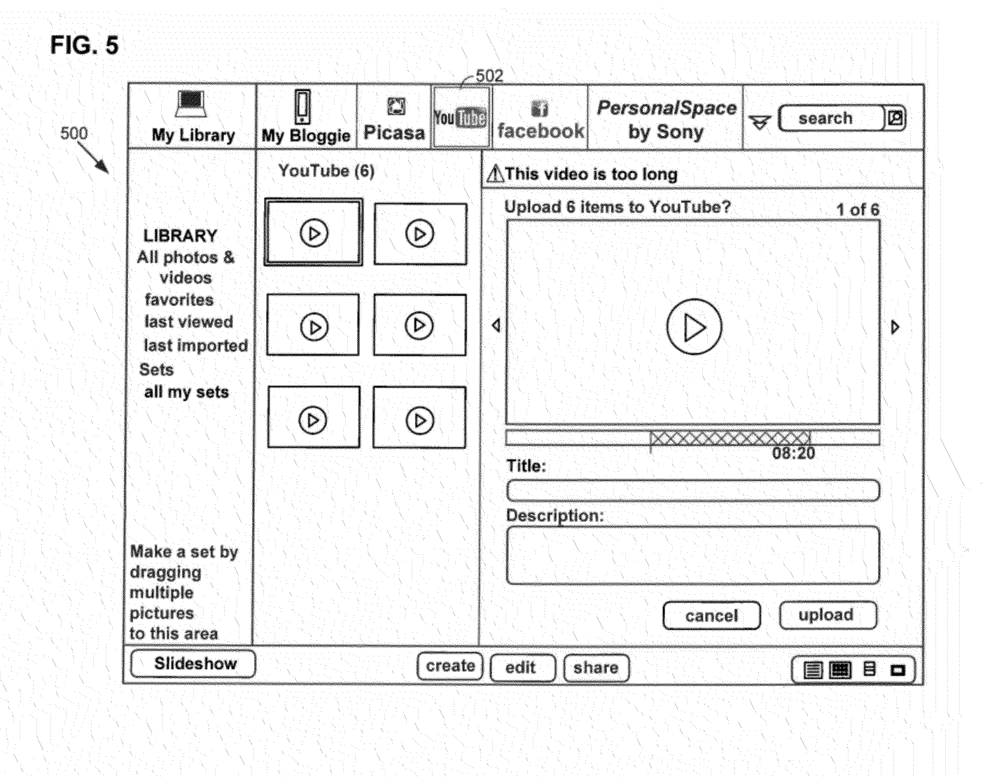

Referring now to FIG. 5, graphical user interface 500 including video management according to an embodiment is shown. A user has selected for example YouTube™ as the desired (and thus highlighted) destination 502 for a collection of six videos. YouTube™ has destination constraints that limit the duration of uploads. The embodiment thus notes that the content item is too long, violating the constraint. The embodiment may reduce the duration or file size of content items, as well as add user-specified dates or other notes, or crop or further compress content items to meet destination constraints.

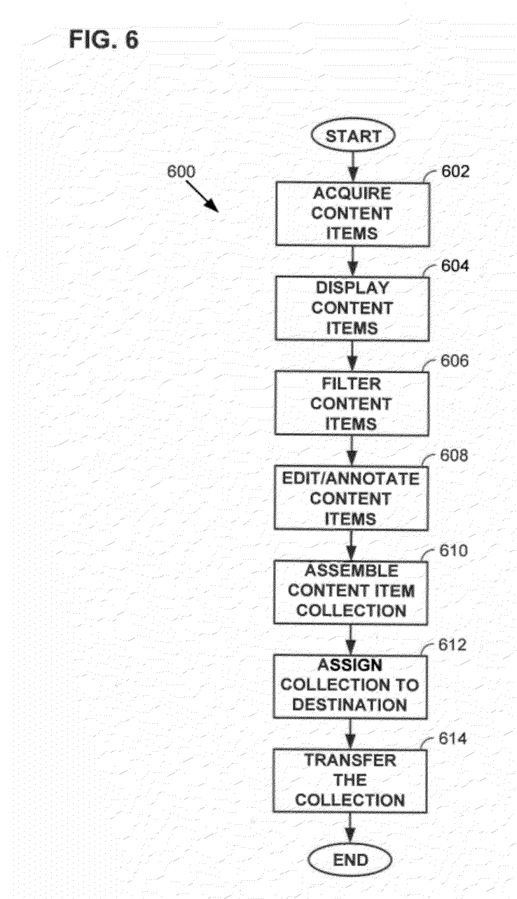

Referring now to FIG. 6, a flowchart of embodiment process 600 is shown. Briefly, a user instructs the embodiment to acquire or import multimedia content items in step 602. The embodiment may then display the content items in step 604. A user may then filter them as desired in step 606. The user may edit or annotate content items in step 608. The embodiment may assemble a collection of content items for the user in step 610, then assign the collection to a destination for transfer in step 612. The embodiment may then transfer the collection as specified in step 614.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc. User input may include any combination of a keyboard, mouse, touch screen, voice command input, etc. User input may similarly be used to direct a browser application executing on a user's computing device to one or more network resources, such as web pages, from which computing resources may be accessed.

While the invention has been described in connection with specific examples and various embodiments, it should be readily understood by those skilled in the art that many modifications and adaptations of the automatic multimedia content item management and sharing tool described herein are possible without departure from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains.

What is claimed is:

1. A computer-implemented method of automatically manipulating and sharing multimedia content items, comprising:
acquiring multimedia content items;
defining related item information by a user of a graphical user interface; and
transferring the multimedia content items and the related item information to selected destinations whereby the related item information is retained.

2. The method of claim 1 wherein the multimedia content items include at least one of a text file, a photograph, a video, an audio file, an HTML file, a mixed media presentation, a PDF document, an executable program file, and a database file.

3. The method of claim 1 wherein the multimedia content items are acquired from at least one of a camera, a phone, a scanner, a memory device, an email, a network, and a computer.

4. The method of claim 1 further comprising editing the multimedia content items by at least one of adding captions, adding dates, adding notes, cropping the items, reducing the file size of the items, and reducing the duration of items.

5. The method of claim 1 wherein the defining includes at least one of adding metadata and specifying the formation of a multimedia content item collection.

6. The method of claim 5 wherein adding metadata includes at least one of adding captions, adding dates, adding notes, adding names to automatically recognized faces.

7. The method of claim 5 wherein specifying the formation includes at least one of selecting particular multimedia content items, determining an attachment sequence, setting transfer constraints, and defining destination constraints.

8. The method of claim 1 wherein the graphical user interface depicts multimedia content items as at least one of icons and thumbnails.

9. The method of claim 1 wherein the multimedia content items and the related item information are represented in the graphical user interface by a collection token.

10. The method of claim 1 wherein the graphical user interface is implemented on at least one of a touchscreen device, a non-networked camera, a networked camera, a non-networked computer, and a networked computer.

11. The method of claim 1 wherein the graphical user interface includes function-specific areas including at least one of a main stage, a filter area, a collection assembly area, a user guidance area, persistent context-sensitive action buttons, and a sharing dock with destination containers.

12. The method of claim 11 wherein the destination container is identified by at least one of a name and a logo.

13. The method of claim 1 wherein the transferring includes moving at least one of a multimedia content item and a collection token into a destination container, and selectively satisfying a user-defined transfer constraint defining at least one of time-based and connection-based triggers.

14. The method of claim 1 wherein the destinations include at least one of: public sites, private sites, email accounts, social networking sites, content publishing sites, interchange servers, and archives.

15. The method of claim 1 wherein the destination is an interchange server that automatically manages an additional transfer to an additional destination that has its own destination constraints.

16. The method of claim 1 further comprising transferring computer-executable program instructions for implementing the graphical user interface from a first computing device to a second computing device.

17. A system for automatically manipulating and sharing multimedia content items, comprising:
a computing device that acquires input multimedia content items;
a graphical user interface for defining related item information by a user; and
a network connection for transferring the multimedia content items and the related item information to selected destinations whereby the related item information is retained.

18. The system of claim 17 wherein the multimedia content items include at least one of a text file, a photograph, a video, an audio file, an HTML file, a mixed media presentation, a PDF document, an executable program file, and a database file.

19. The system of claim 17 wherein the multimedia content items are acquired from at least one of a camera, a phone, a scanner, a memory device, an email, a network, and a computer.

20. The system of claim 17 wherein the multimedia content items are edited by at least one of adding captions, adding dates, adding notes, cropping the items, reducing the file size of the items, and reducing the duration of items.

21. The system of claim 17 wherein the defining includes at least one of adding metadata and specifying the formation of a multimedia content item collection.

22. The system of claim 21 wherein adding metadata includes at least one of adding captions, adding dates, adding notes, adding names to automatically recognized faces.

23. The system of claim 21 wherein specifying the formation includes at least one of selecting particular multimedia content items, determining an attachment sequence, setting transfer constraints, and defining destination constraints.

24. The system of claim 17 wherein the graphical user interface depicts multimedia content items as at least one of icons and thumbnails.

25. The system of claim 17 wherein the multimedia content items and the related item information are represented in the graphical user interface by a collection token.

26. The system of claim 17 wherein the graphical user interface is implemented on at least one of: a touchscreen device, a non-networked camera, a networked camera, a non-networked computer, and a networked computer.

27. The system of claim 17 wherein the graphical user interface includes function-specific areas including at least one of a main stage, a filter area, a collection assembly area, a user guidance area, persistent context-sensitive action buttons, and a sharing dock with destination containers.

28. The system of claim 27 wherein the destination container is identified by at least one of a name, and a logo.

29. The system of claim 17 wherein the transferring includes moving at least one of a multimedia content item and a collection token into a destination container, and selectively satisfying a user-defined transfer constraint defining at least one of time-based and connection-based triggers.

30. The system of claim 17 wherein the destinations include at least one of public sites, private sites, email accounts, social networking sites, content publishing sites, interchange servers, and archives.

31. The system of claim 17 wherein the destination is an interchange server that automatically manages an additional transfer to an additional destination that has its own destination constraints.

32. The system of claim 17 further comprising transferring computer-executable program instructions for implementing the graphical user interface from a first computing device to a second computing device.

33. A computer program product comprising a computer readable medium tangibly embodying non-transitory computer-executable program instructions thereon to cause a computing device to automatically manipulate and share multimedia content items, the instructions comprising:
acquiring multimedia content items;
defining related item information by a user of a graphical user interface; and
transferring the multimedia content items and the related item information to selected destinations whereby the related item information is retained.

34. A system for automatically manipulating and sharing multimedia content items, comprising means for:
acquiring multimedia content items;
defining related item information by a user of a graphical user interface; and
transferring the multimedia content items and the related item information to selected destinations whereby the related item information is retained.
